(19) United States
(12) Patent Application Publication
(10) Pub. No.: US 2026/0135431 A1
(43) Pub. Date: May 14, 2026

(54) BRUSHLESS HOLLOW CUP MOTOR

(71) Applicant: AAC MICROTECH (CHANGZHOU) CO., LTD., Changzhou (CN)

(72) Inventors: Jinguo Wu, Changzhou (CN); Sensen Yang, Changzhou (CN); Feng Yan, Changzhou (CN); Junsheng Wang, Changzhou (CN)

(21) Appl. No.: 19/326,683

(22) Filed: Sep. 11, 2025

Related U.S. Application Data
(63) Continuation of application No. PCT/CN2024/131597, filed on Nov. 12, 2024.

(51) Int. Cl. H02K 5/15; H02K 1/2706; H02K 5/167; H02K 5/173; H02K 11/215

(52) U.S. Cl. CPC H02K 5/15; H02K 1/2706; H02K 5/1675; H02K 5/1735; H02K 11/215; H02K 2203/03; H02K 2211/03

(57) ABSTRACT

The present application provides a brushless hollow cup motor including a housing, a stator assembly fixed in the housing, a rotor assembly supported in the housing, a first bearing, and a second bearing. The housing includes a first cover plate, a second cover plate, and a housing body sandwiched between the cover plates. The rotor assembly is supported on the first and second cover plates and forms a rotational connection. The first bearing is a ball bearing and the second bearing is an oil bearing. The first cover plate and the second cover plate are recessed to form a first groove and a second groove, respectively. The rotor assembly are fixed to the inner peripheral sides of the first and second bearings. The present application ensures that the axial and radial movements of the rotor are maintained in a reasonable range, thereby improving the motor's operational stability.

### CROSS-REFERENCE TO RELATED APPLICATIONS

This application is a continuation of International Application No. PCT/CN2024/131597, Nov. 12, 2024, the entire contents of which are incorporated herein by reference.

### TECHNICAL FIELD

The present application relates to the field of motor technologies, in particular to a brushless hollow cup motor.

### BACKGROUND

Brushless hollow cup motors, characterized by their compact structure, high power density, high operational efficiency, and significant energy-saving benefits, have been widely applied in fields such as electric motors and generators. In recent years, the industrial sector has increasingly demanded equipment that uses brushless hollow cup motors to directly drive loads. The widespread application of these direct-drive devices powered by brushless hollow cup motors is expected to yield immeasurable energy-saving benefits.

In the related art, most of the traditional brushless hollow cup motors include a housing, a rotor, and a stator spaced around the rotor. The housing includes a cover plate and a housing body, and the portion of the rotor of the brushless hollow cup motor that is connected to the housing usually uses bearings to provide axial and radial positioning of the rotor. However, the traditional brushless hollow cup motors use ball bearings at both the front and rear ends of the rotor to provide axial and radial positioning. The amount of radial movement of the shaft is limited by the amount of radial movement of the shaft in the inner and outer rings of the ball bearings, and the amount of radial movement of the shaft in the inner and outer rings of the ball bearings is too small, which affects the rolling efficiency of the steel balls, which leads to the instability of the rotation of the motor. Besides, adopting a ball bearing structure puts forward higher requirements for the inner and outer rings and for the process of the steel balls.

Therefore, it is necessary to provide a new brushless hollow cup motor to solve the above technical problems.

### SUMMARY

An object of the present application is to provide a brushless hollow cup motor with better axial and radial movement control and better rotational stability.

In order to achieve the above object, the present application provides a brushless hollow cup motor, including:
a housing including a first cover plate, a second cover plate, and a hollow housing body sandwiched between the first cover plate and the second cover plate;
a rotor assembly supported in the housing and rotatably connected to the housing, wherein two ends of the rotor assembly are supported on the first cover plate and the second cover plate, respectively, and rotatably connected to the first cover plate and the second cover plate, respectively;
a stator assembly fixed in the housing, the stator assembly being fixed to an inner peripheral side of the housing body and spaced around an outer peripheral side of the rotor assembly;
a first bearing; and
a second bearing;
wherein the first bearing is a ball bearing, and the second bearing is an oil bearing; a side of the first cover plate close to the housing body is recessed to form a first groove, and a side of the second cover plate close to the housing body is recessed to form a second groove coaxially provided with the first groove; an outer peripheral side of the first bearing is fixed in the first groove, and an outer peripheral side of the second bearing is fixed in the second groove; the two ends of the rotor assembly are inserted and fixed to an inner peripheral side of the first bearing and an inner peripheral side of the second bearing, respectively.

In an embodiment, the first cover plate includes a first cover body, a first fixing ring formed by protruding and extending from a side of the first cover body close to the housing body, and a second fixing ring formed by protruding and extending from a side of the first fixing ring close to the housing body, wherein the first fixing ring is abutted against the housing body, and the second fixing ring is inserted within an open end of the housing; the first groove is formed in an inner periphery of the second fixing ring, and the outer peripheral side of the first bearing is welded and fixed within the first groove.

In an embodiment, the second cover plate includes a second cover body and a third fixing ring formed by protruding and extending from a side of the second cover body close to the housing body; the second groove is formed in an inner peripheral side of the third fixing ring, and the outer peripheral side of the second bearing is riveted and fixed within the second groove.

In an embodiment, the stator assembly includes a stator coil coaxially provided with the housing body and fixed to the inner peripheral side of the housing body.

In an embodiment, the rotor assembly includes a rotor shaft rotatably connected to the first cover plate and the second cover plate, an iron core fixedly sleeved on the rotor shaft, and a permanent magnet fixedly sleeved on the iron core, wherein the permanent magnet is spaced apart from the stator assembly.

In an embodiment, the brushless hollow cup motor further includes a circuit board, wherein the circuit board is fixed to a side of the second cover plate away from the first cover plate, the stator assembly is electrically connected to the circuit board, and the circuit board is provided with an outlet terminal.

In an embodiment, the brushless hollow cup motor further includes a machine casing in a hollow structure, wherein the machine casing is fixedly sleeved on an outer peripheral side of the housing, and the machine casing is made of a magnetically conductive material.

In an embodiment, a side of the machine casing is provided with a through-hole arranged through the machine casing, and a wire for connecting the outlet terminal is extended to an outer side of the housing through the through-hole.

In an embodiment, the brushless hollow cup motor further includes a sensor assembly, which is configured to detect rotation data of the rotor assembly and includes a sensor magnet fixedly sleeved on an end of the rotor assembly away from the second bearing and a Hall sensor fixed to a side of the circuit board close to the second cover plate, wherein the Hall sensor is arranged opposite to and spaced from the sensor magnet.

Compared to the related art, the brushless hollow cup motor of the present application includes a housing, a stator assembly fixed in the housing, and a rotor assembly supported in the housing and rotatably connected to the housing. The housing includes a first cover plate, a second cover plate, and a hollow housing body sandwiched between the first cover plate and the second cover plate. The stator assembly is fixed to an inner peripheral side of the housing body, and spaced around the outer peripheral side of the rotor assembly. Two ends of the rotor assembly are supported on the first cover plate and the second cover plate, respectively, and are rotatably connected to the first cover plate and the second cover plate, respectively. The brushless hollow cup motor further includes a first bearing and a second bearing, in which the first bearing is a ball bearing and the second bearing is an oil bearing. A side of the first cover plate close to the housing body is recessed to form a first groove, and a side of the second cover plate close to the housing body is recessed to form a second groove coaxially provided with the first groove. An outer peripheral side of the first bearing is fixed in the first groove, and an outer peripheral side of the second bearing is fixed in the second groove. The two ends of the rotor assembly are inserted and fixed to an inner peripheral side of the first bearing and an inner peripheral side of the second bearing, respectively. In the aforementioned structure, the axial movement of the motor is controlled by a ball bearing at the front end of the rotor, while the radial movement is controlled by an oil-impregnated bearing at the rear end of the rotor. This combination of two types of bearings ensures that the axial and radial movements of the rotor of the motor remain within a reasonable range, reducing abnormal noise caused by rotational instability and improving the motor's operational stability.

### BRIEF DESCRIPTION OF THE DRAWINGS

In order to more clearly illustrate the technical solutions in the embodiments of the present application, the accompanying drawings that need to be used in the description of the embodiment will be briefly introduced as follows. Obviously, the accompanying drawings in the following description are only some of the embodiments of the present application, and for the person of ordinary skill in the field, other accompanying drawings may be obtained based on these drawings without putting forth any creative labor.

FIG. 1 shows a schematic diagram of a three-dimensional structure of a brushless hollow cup motor according to an embodiment of the present application.

FIG. 2 shows an exploded view of the three-dimensional structure of the brushless hollow cup motor according to an embodiment of the present application.

FIG. 3 shows an exploded view of the three-dimensional structure of another view of the brushless hollow cup motor according to an embodiment of the present application.

FIG. 4 shows a sectional view of the brushless hollow cup motor of FIG. 1 along line A-A.

FIG. 5 shows a schematic diagram of an assembly structure of a first bearing and a second bearing according to an embodiment of the present application.

### DETAILED DESCRIPTION OF THE EMBODIMENTS

The technical solutions in the embodiments of the present application will be described clearly and completely in the following in conjunction with the accompanying drawings in the embodiments of the present application. Obviously, the described embodiments are only a part of the embodiments of the present application and not all of the embodiments. Based on the embodiments in the present application, all other embodiments obtained by a person of ordinary skill in the art without making creative labor fall within the scope of protection of the present application.

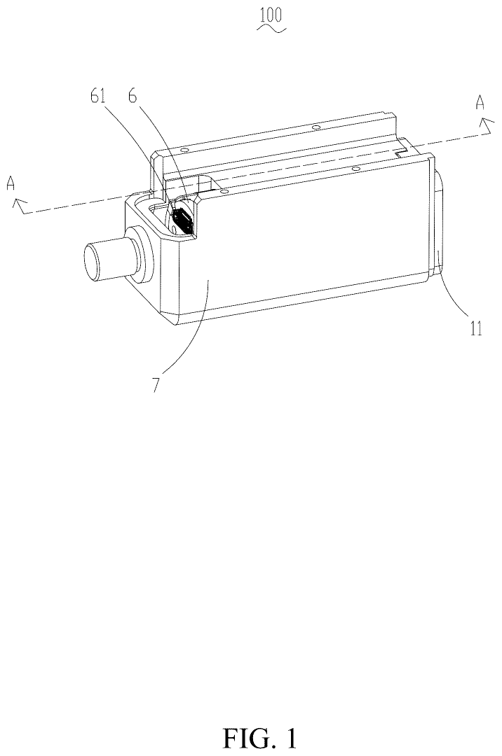

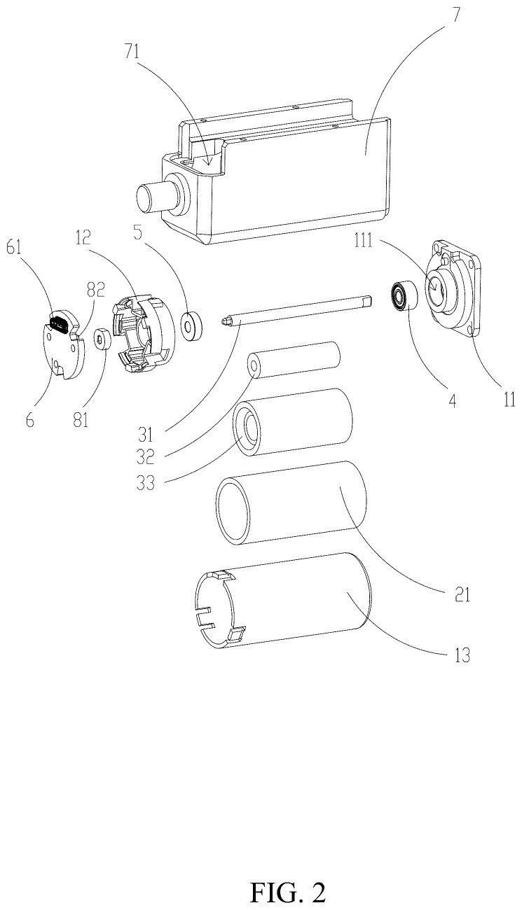

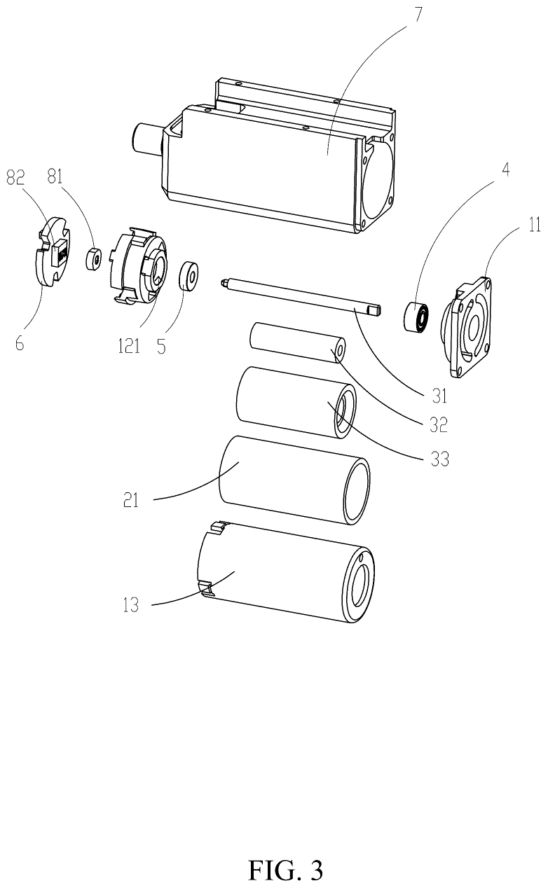

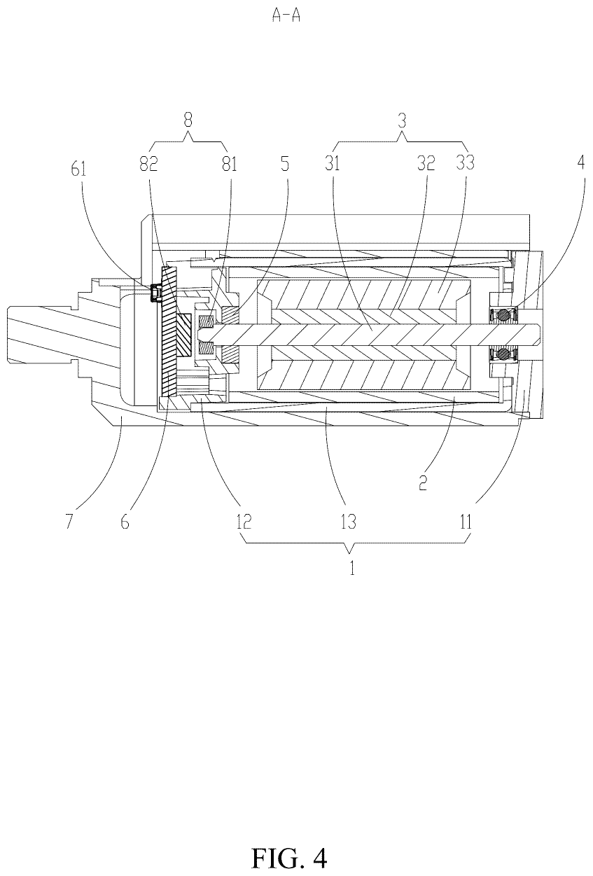

As shown in FIGS. 1 to 5, FIG. 1 shows a schematic diagram of a three-dimensional structure of a brushless hollow cup motor according to an embodiment of the present application, FIG. 2 shows an exploded view of the three-dimensional structure of the brushless hollow cup motor according to an embodiment of the present application, FIG. 3 shows an exploded view of the three-dimensional structure of another view of the brushless hollow cup motor according to an embodiment of the present application, and FIG. 4 shows a sectional view of the brushless hollow cup motor of FIG. 1 along line A-A. Embodiments of the present application provide a brushless hollow cup motor 100 including a housing 1, a stator assembly 2 fixed within the housing 1, and a rotor assembly 3 supported in the housing 1 and rotatably connected to the housing 1.

The housing 1 includes a first cover plate 11, a second cover plate 12, and a hollow housing body 13 sandwiched between the first cover plate 11 and the second cover plate 12.

The stator assembly 2 is fixed to the inner peripheral side of the housing body 13 and spaced around the outer peripheral side of the rotor assembly 3.

Two ends of the rotor assembly 3 are supported on the first cover plate 11 and the second cover plate 12, respectively, and rotatably connected to the first cover plate 11 and the second cover plate 12, respectively.

Specifically, as shown in FIGS. 2 and 3, the brushless hollow cup motor 100 further includes a first bearing 4 and a second bearing 5. The first bearing 4 is a ball bearing, and the second bearing 5 is an oil bearing. A side of the first cover plate 11 close to the housing body 13 is recessed to form a first groove 111, and a side of the second cover plate 12 close to the housing body is recessed to form a second groove coaxially provided with the first groove 111. An outer peripheral side of the first bearing 4 is fixed in the first groove 111, and an outer peripheral side of the second bearing 5 is fixed in the second groove 121. The two ends of the rotor assembly 3 are inserted and fixed in an inner peripheral side of the first bearing 4 and an inner peripheral side of the second bearing 5, respectively.

In the above structure, the side where the first bearing 4 is located is the front end of the brushless hollow cup motor 100, and the side where the second bearing 5 is located is the rear end of the brushless hollow cup motor 100. The axial movement of the motor is controlled by a ball bearing at the front end, while the radial movement is controlled by an oil-impregnated bearing at the rear end. This combination of two types of bearings ensures that the axial and radial movements of the rotor of the motor remain within a reasonable range, reducing abnormal noise caused by rotational instability and improving the motor's operational stability.

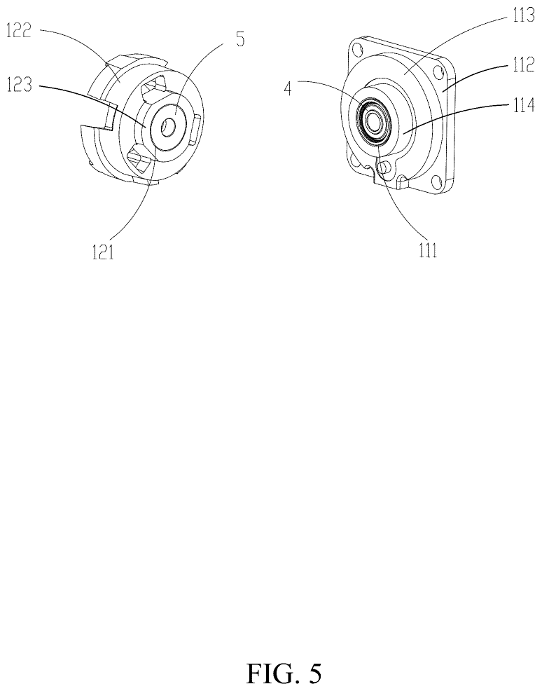

In an embodiment, as shown in the schematic diagram of the assembly structure in FIG. 5, in the embodiment of the present application, the first cover plate 11 includes a first cover body 112, a first fixing ring 113 formed by protruding and extending from a side of the first cover body 112 close to the housing body 13, and a second fixing ring 114 formed by protruding and extending from a side of the first fixing ring 113 close to the housing body. The first fixing ring 113 is abutted against the first fixing ring 113, and the second fixing ring 114 is inserted within an open end of the housing 1. The first groove 111 is formed in an inner peripheral side of the second fixing ring 114, and an outer peripheral side of the first bearing 4 is welded and fixed within the first groove 111.

The second cover plate 12 includes a second cover body 122 and a third fixing ring 123 formed by protruding and extending from a side of the second cover body 122 close to the housing body. The second groove 121 is formed in the inner peripheral side of the third fixing ring 123, and the outer peripheral side of the second bearing 5 is riveted and secured within the second groove 121. For ball bearings, welding ensures the stability of the connection between the outer ring of the bearing and the first cover plate 11 while not affecting the rotation of the inner ring. This ensures the axial stability of the ball bearing within the motor. For oil bearings, riveting ensures that the gap between the bearing and the groove of the second cover plate 12 is controlled, thereby maintaining the radial stability of the oil-impregnated bearing within the motor.

As shown in FIGS. 2 and 3, the stator assembly 2 includes a stator coil 21 coaxially provided with the housing body 13 and fixed to the inner peripheral side of the housing body 13. In this embodiment of the present application, the stator coil 21 and the rotor assembly 3 generate a magnetic field with each other so as to drive the rotation of the rotor assembly 3.

The rotor assembly 3 includes a rotor shaft 31 rotatably connected to the first cover plate 11 and the second cover plate 12, an iron core 32 fixedly sleeved on the rotor shaft 31, and a permanent magnet 33 fixedly sleeved on the iron core 32. The permanent magnet 33 is spaced apart from the stator assembly 2. By means of the stator assembly 2 and the stator coil 21 mutually generating a magnetic field, the rotor shaft 31 is driven to rotate between the first cover plate 11 and the second cover plate 12, thereby realizing a motor rotation effect.

The brushless hollow cup motor 100 further includes a circuit board 6, which is fixed to the side of the second cover plate 12 away from the first cover plate 11. The stator assembly 2 is electrically connected to the circuit board 6, and the circuit board 6 is provided with an outlet terminal 61.

The brushless hollow cup motor 100 further includes a machine casing 7 in a hollow structure. The machine casing 7 is fixedly sleeved on an outer peripheral side of the housing, and the machine casing 7 is made of a magnetically conductive material. The magnetically conductive material of the machine casing is designed to facilitate the improvement of the magnetic strength of the stator assembly 2 in order to improve the performance of the motor.

A side of the machine casing 7 is provided with a through-hole 71 arranged through the machine casing 7, and a wire for connecting the outlet terminal 61 is extended to the outer side of the machine casing 7 through the through-hole 71.

In the embodiment of the present application, the position of the through-hole 71 makes the position of the motor outlet wire clear, facilitates assembly, and reduces the complexity of motor assembly.

The brushless hollow cup motor 100 further includes a sensor assembly 8, which is configured to detect rotation data of the rotor assembly 3. The sensor assembly 8 includes a sensor magnet 81 fixedly sleeved on an end of the rotor assembly 3 away from the second bearing 5 and a Hall sensor 82 fixed to a side of the circuit board 6 close to the second cover plate 12. The Hall sensor 82 is arranged opposite to and spaced from the sensor magnet 81.

In the embodiment of the present application, the rotation data of the rotor shaft 31 is collected by the sensor magnet 81, and the Hall sensor 82 senses and realizes the data collection with the sensor magnet 81. The Hall sensor 82 carries out the processing of the rotation data, and the circuit board 6 uniformly collects the data of the sensor, and then transmits the processed data to an external device for displaying, so as to facilitate the realization of the motor control.

Compared to the related art, the brushless hollow cup motor of the present application includes a housing, a stator assembly fixed in the housing, and a rotor assembly supported in the housing and rotatably connected to the housing. The housing includes a first cover plate, a second cover plate, and a hollow housing body sandwiched between the first cover plate and the second cover plate. The stator assembly is fixed to an inner peripheral side of the housing body, and spaced around the outer peripheral side of the rotor assembly. Two ends of the rotor assembly are supported on the first cover plate and the second cover plate, respectively, and are rotatably connected to the first cover plate and the second cover plate, respectively. The brushless hollow cup motor further includes a first bearing and a second bearing, in which the first bearing is a ball bearing and the second bearing is an oil bearing. A side of the first cover plate close to the housing body is recessed to form a first groove, and a side of the second cover plate close to the housing body is recessed to form a second groove coaxially provided with the first groove. An outer peripheral side of the first bearing is fixed in the first groove, and an outer peripheral side of the second bearing is fixed in the second groove. The two ends of the rotor assembly are inserted and fixed to an inner peripheral side of the first bearing and an inner peripheral side of the second bearing, respectively. In the aforementioned structure, the axial movement of the motor is controlled by a ball bearing at the front end of the rotor, while the radial movement is controlled by an oil-impregnated bearing at the rear end of the rotor. This combination of two types of bearings ensures that the axial and radial movements of the rotor of the motor remain within a reasonable range, reducing abnormal noise caused by rotational instability and improving the motor's operational stability.

Described above are only embodiments of the present application, and it should be pointed out that, for the ordinary technical personnel in the field, improvements may also be made without departing from the premise of the concept of the present application, but these are all within the protection scope of the present application.

What is claimed is:

1. A brushless hollow cup motor, comprising:
a housing comprising a first cover plate, a second cover plate, and a hollow housing body sandwiched between the first cover plate and the second cover plate;
a rotor assembly supported in the housing and rotatably connected to the housing, wherein two ends of the rotor assembly are supported on the first cover plate and the second cover plate, respectively, and rotatably connected to the first cover plate and the second cover plate, respectively;
a stator assembly fixed in the housing, the stator assembly being fixed to an inner peripheral side of the housing body and spaced around an outer peripheral side of the rotor assembly;
a first bearing; and
a second bearing;
wherein the first bearing is a ball bearing, and the second bearing is an oil bearing; a side of the first cover plate close to the housing body is recessed to form a first groove, and a side of the second cover plate close to the housing body is recessed to form a second groove coaxially provided with the first groove; an outer peripheral side of the first bearing is fixed in the first groove, and an outer peripheral side of the second bearing is fixed in the second groove; the two ends of the rotor assembly are inserted and fixed to an inner peripheral side of the first bearing and an inner peripheral side of the second bearing, respectively.

2. The brushless hollow cup motor of claim 1, wherein the first cover plate comprises a first cover body, a first fixing ring formed by protruding and extending from a side of the first cover body close to the housing body, and a second fixing ring formed by protruding and extending from a side of the first fixing ring close to the housing body, wherein the first fixing ring is abutted against the housing body, and the second fixing ring is inserted within an open end of the housing; the first groove is formed in an inner periphery of the second fixing ring, and the outer peripheral side of the first bearing is welded and fixed within the first groove.

3. The brushless hollow cup motor of claim 1, wherein the second cover plate comprises a second cover body and a third fixing ring formed by protruding and extending from a side of the second cover body close to the housing body; the second groove is formed in an inner peripheral side of the third fixing ring, and the outer peripheral side of the second bearing is riveted and fixed within the second groove.

4. The brushless hollow cup motor of claim 1, wherein the stator assembly comprises a stator coil coaxially provided with the housing body and fixed to the inner peripheral side of the housing body.

5. The brushless hollow cup motor of claim 1, wherein the rotor assembly comprises a rotor shaft rotatably connected to the first cover plate and the second cover plate, an iron core fixedly sleeved on the rotor shaft, and a permanent magnet fixedly sleeved on the iron core, wherein the permanent magnet is spaced apart from the stator assembly.

6. The brushless hollow cup motor of claim 1, further comprising a circuit board, wherein the circuit board is fixed to a side of the second cover plate away from the first cover plate, the stator assembly is electrically connected to the circuit board, and the circuit board is provided with an outlet terminal.

7. The brushless hollow cup motor according to claim 6, further comprising a machine casing in a hollow structure, wherein the machine casing is fixedly sleeved on an outer peripheral side of the housing, and the machine casing is made of a magnetically conductive material.

8. The brushless hollow cup motor of claim 7, wherein a side of the machine casing is provided with a through-hole arranged through the machine casing, and a wire for connecting the outlet terminal is extended to an outer side of the housing through the through-hole.

9. The brushless hollow cup motor of claim 6, further comprising a sensor assembly, which is configured to detect rotation data of the rotor assembly and comprises a sensor magnet fixedly sleeved on an end of the rotor assembly away from the second bearing and a Hall sensor fixed to a side of the circuit board close to the second cover plate, wherein the Hall sensor is arranged opposite to and spaced from the sensor magnet.
